(19) United States
(12) Patent Application Publication
(10) Pub. No.: US 2018/0042208 A1
(43) Pub. Date: Feb. 15, 2018

(54) Fishing Reel Cover

(71) Applicant: Robert John Slack, Lake George, NY (US)

(72) Inventor: Robert John Slack, Lake George, NY (US)

(21) Appl. No.: 15/675,276

(22) Filed: Aug. 11, 2017

Related U.S. Application Data
(60) Provisional application No. 62/374,555, filed on Aug. 12, 2016.

(51) Int. Cl. A01K 89/033; A01K 89/015

(52) U.S. Cl. CPC A01K 89/033; A01K 89/015; A01K 97/08

(57) ABSTRACT

A cover for a fishing reel installed on a fishing rod can easily be drawn over and tightened in a matter of seconds to protect the reel without removing it from the rod. The cover has an open lower end to allow humidity to escape while the upper end encloses the reel and provides protection for any size or type of reel. The cover is lightweight and flexible. It can fit into any shirt, coat or pants pocket between uses.

### CROSS REFERENCE TO RELATED APPLICATION

The present application claims priority to U. S. Provisional Patent Application Ser. No. 62/374,555, filed Aug. 12, 2016 by the same inventor and entitled “REELdry Fishing Reel Protective Shroud.”

### BACKGROUND OF THE INVENTION

### 1. Field of the Invention

The present invention generally relates to protective covers for equipment used out-of-doors and more particularly to flexible covers adapted to enclosing complex mechanisms such as fishing reels from the effects of weather or weather-borne substances.

### 2. Description of the Invention and Background of the Prior Art

Fishing reels are precision mechanisms used in out-of-doors environments where they are subject to weather conditions, particularly during rainy or stormy weather or during conditions upon the sea, lake, or river where over spray can find its way into the mechanism and fishing line of the reel. A cover is useful especially when traveling along the water to protect the reel from overspray and other forms of contamination.

Conventional covers for fishing reels tend to be bulky and often difficult to secure or remove quickly. Other covers are not waterproof or do not provide sufficient ventilation to permit wet reels and fishing line to air dry. An airtight cover traps humidity, and lead to deterioration of the fishing line or corrosion of metal parts of the reel mechanism.

What is needed is a cover for a fishing reel that solves these problems and provides a covering device that is easier to use, durable, and low cost.

### SUMMARY OF THE INVENTION

In one embodiment a cover or shroud for a fishing reel installed on a fishing rod is disclosed comprising a bag formed from a rectangular piece of waterproof fabric having opposite first and second longer sides and opposite first and second shorter sides, wherein the first longer side is hemmed with a drawstring cord disposed within the hem and extending from each end of the hem by a predetermined length to form first and second tie ends. The second longer side opposite the first longer side may also be hemmed. The first and second shorter sides are sewn together, and the bag thus formed is turned inside out to dispose an edge of the sewn first and second shorter sides inside the bag.

In another aspect, the first and second tie ends are formed into a knot; and a draw string lock is disposed over the first and second tie ends between the knot and the cover.

In another aspect, the cover is constructed of a waterproof fabric such as nylon, synthetic sheet, fabric woven of waterproof fibers, canvas, muslin, rubberized cloth and the like.

In another aspect, one convenient size of the cover is provided that is approximately 12 inches long and 9 inches wide.

In other aspects, eyelets for the drawstring cord may be positioned at each end of the upper edge hem; and two-piece, press-fit fasteners may be attached to opposite corners on opposite sides of the lower edge of the cover to more closely secure the cover around a reel.

### BRIEF DESCRIPTION OF THE DRAWINGS

FIG. 1 illustrates a finished perspective view of one embodiment of a fishing reel cover according to the present invention;

FIG. 2 illustrates a rectangular panel of material from which the embodiment of FIG. 1 according to the present invention may be constructed, and shown after several preliminary steps in its construction have been completed;

FIG. 3 illustrates the embodiment of FIG. 2, after remaining construction steps have been completed;

FIG. 4 illustrates an approximate form of the embodiment of FIGS. 2 and 3 after a drawstring disposed within hem of one end has been pulled to close one end of the cover;

FIG. 5 illustrates several fishing reel covers in use as installed over the fishing reels of several rod and reel combinations supported on the stern of a boat;

FIG. 6 illustrates a cord lock for use in the embodiments of FIGS. 1-5 to secure the drawstring cord of the fishing reel cover;

FIG. 7 illustrates a cover according to the embodiment of FIG. 1 with a first member of an optional two-piece press-fit fastener; and

FIG. 8 illustrates a cover according to the embodiment of FIG. 1 with a second member of an optional two-piece press-fit fastener.

### DETAILED DESCRIPTION OF THE INVENTION

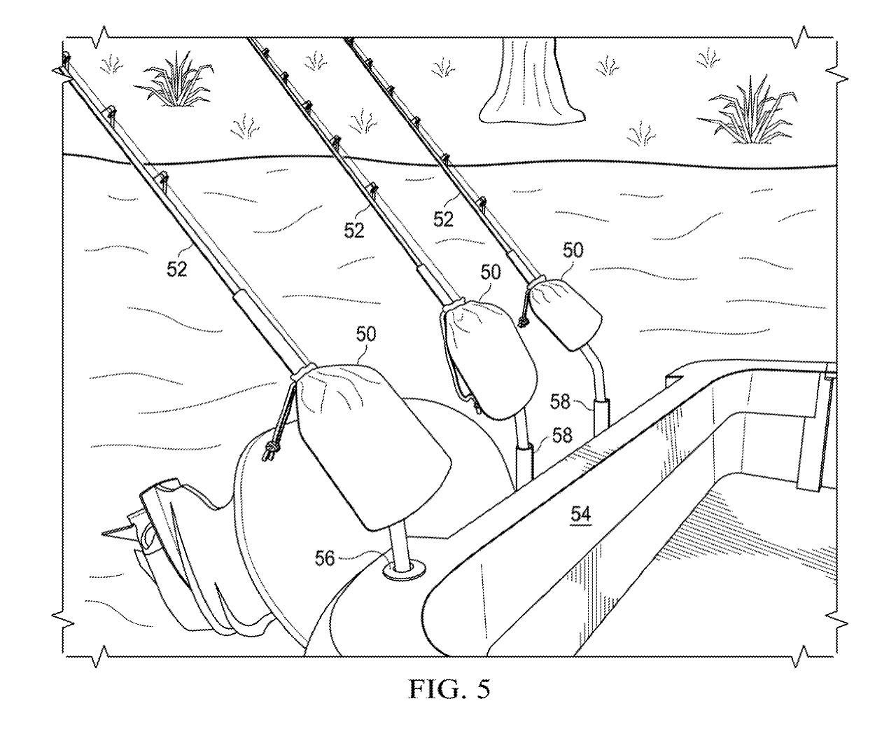

In an advance in the state of the art a waterproof cover or shroud for a fishing reel is described. The cover is formed of lightweight, flexible materials that are waterproof, easily sewn, and can be made by several simple manufacturing steps. An example of the fishing reel cover and its use is shown in FIG. 5.

The claimed invention is distinguished by its open ended design, thus creating a breathable environment that will not trap humidity so the reel casing can dry out as if stored indoors. In addition it is flexible, lightweight, and adaptable to any size reel by increasing or decreasing the blank size of the fabric or plastic panel.

Moreover the fishing reel cover as described is easy to install and secure. The reel does not have to be removed from its rod to protect it from the effects of the weather. Its simple structure and the drawstring and sliding string lock system enables quick and secure installation and removal. The flexible cover provides a roomy yet compact shroud to fully protect the reel from the elements when the reel is not in use. Its compact design permits closely-racked fishing rods with reels installed, to be well protected by the present invention. Further, the design is easily scaled up or down to fit various sizes and types of fishing reels. Thus, weather-borne elements, rain, hail, snow, dust, or other debris are prevented from reaching the fishing reel.

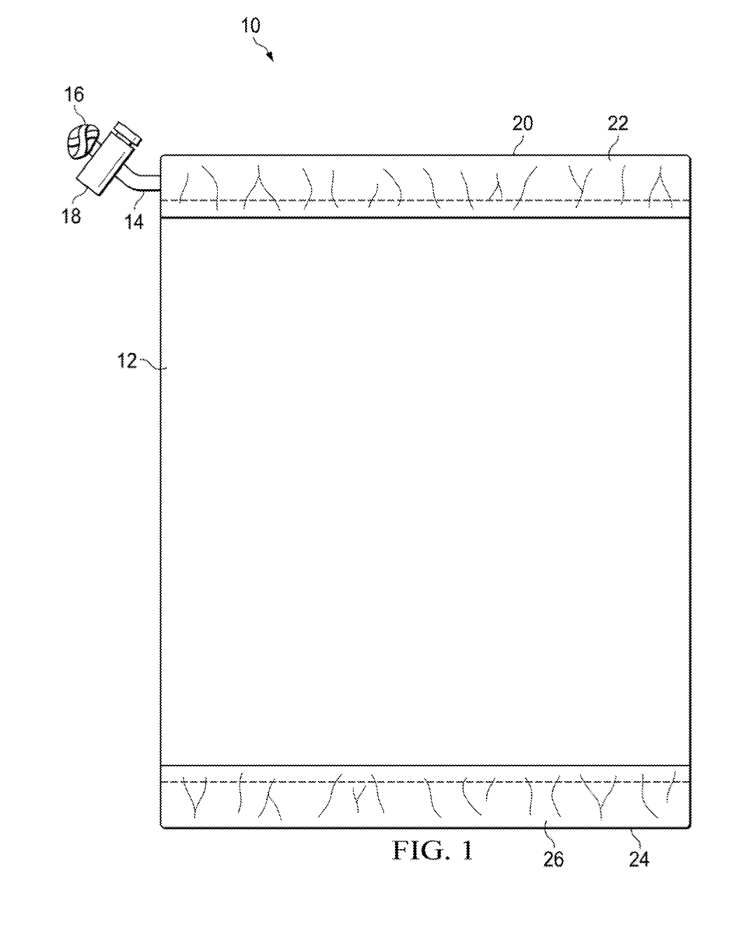

FIG. 1 illustrates a finished perspective view of one embodiment of a fishing reel cover 10 according to the present invention. The invention has three components: a fabric bag 12 open at two opposite ends, an upper end 20 and a lower end 24. A drawstring 14 (or drawstring cord 14) is sewn into an upper hem 22 formed around an upper end 20 of the fabric bag 12, and a drawstring lock 18 is disposed on the free first 28 and second 38 ends of the drawstring 14 to secure the upper open end 20 around a fishing rod 52 just above the reel (not shown but is attached to the fishing rod 52 and enclosed within the cover 10 as depicted in FIG. 5. The cover 10 is then disposed as a shroud over the fishing reel to protect it from the weather, moisture, and debris.

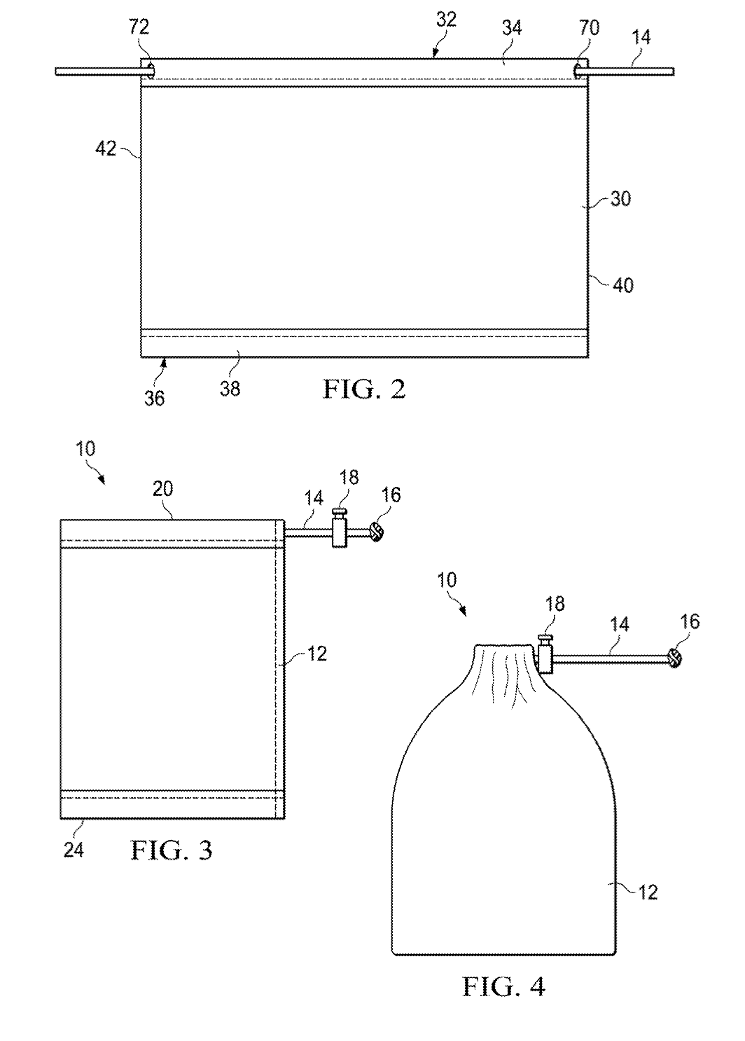

FIG. 2 illustrates a rectangular panel of material from which the embodiment of FIG. 1 according to the present invention may be constructed. The material for the cover 10 may be selected from thin, durable, waterproof materials such as nylon, synthetic plastic sheet, fabric woven of waterproof fibers, rubberized cloth, canvas, muslin, and like materials. The cover 10 is shown after several preliminary steps in its construction have been completed. To begin construction, a piece of waterproof fabric 30 approximately 19″ long and 13″ wide is hemmed 34, 38 along its first 32 and second 36 longer, opposite edges using a suitable water-resistant thread (not shown) or a heat-welding process if the cover 10 is to be made of a plastic sheet material. The first longer edge forms the upper end 20 of the cover 10. The second longer edge forms the lower end 24 of the cover 10. Thus, a hem 34 is formed along the upper edge (the first longer edge 32), and a hem 38 is formed along the lower edge (the second longer edge 36). A length of drawstring cord 14, cut to approximately 4 to 6 inches longer than the length of the fabric 30, is enclosed within the hem 34 with an equal length of the drawstring cord 14 extending from each end of the upper hem 34. The hems 34, 38 should be at least ⅛ inch wide but may be wider—for example up to ¼ or ⅜ inch wide—depending on the thickness of the drawstring cord 14 selected for the cover 10.

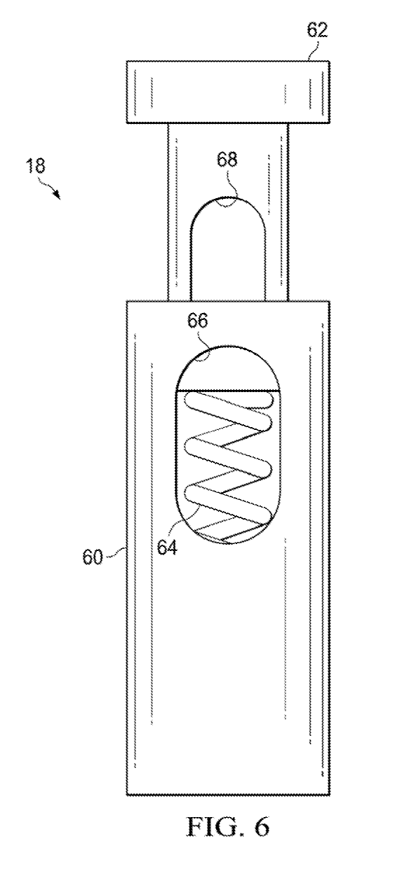

The drawstring cord 14 is preferably a thin, heavy duty cord formed of water proof materials such as nylon thread. The threads used to make the drawstring cord 14 may be twisted or braided. The drawstring lock 18 (or cord lock 18) may preferably be a “spring stopper cord lock,” available from several manufacturers. In one example shown in FIG. 6, the cord lock 18 may include a body 60 and a plunger (or stopper) 62 retained in the body 60. The plunger 62 may be pressed inward of the body 60 against an internal spring 64. Pressing the plunger 62 inward aligns holes 66, 68 respectively through both the body 60 and the plunger 62 to allow insertion of a drawstring cord 14 (or pair of drawstring cords 14). Releasing the plunger 62 misaligns the holes 66, 68 to “lock” the spring stopper cord lock in position on the ends of the drawstring cord 14.

In alternative embodiments the bag 12 may be constructed to be much longer to enclose to lower end of a fishing rod and rolled up when installed on a rod and reel assembly. The lower end of the cover 10 may also include a drawstring cord fashioned in the same manner as the drawstring cord 14 described for the upper end of the cover 10. To provide ventilation when a longer cover 10 is used, the cover 10 may include openings (not shown) in the lower sides. In another alternative embodiment, a first 70 and a second 72 eyelet may be included in each end of the hem 34 constructed along the first upper edge 32 of the fabric 30, as shown in FIG. 2. The eyelets 70, 72 may be provided to reduce wear on the hem 34 when the drawstring cord 14 is drawn through them when installing or removing the cover 10.

FIG. 3 illustrates the embodiment of FIG. 2, after remaining construction steps have been completed. After preparation as shown in FIG. 2, the hemmed fabric blank or panel 30 is folded to bring its first 40 and second 42 shorter sides together and sewn along their respective edges. The hemmed fabric panel 30 thus formed as shown in FIG. 3 is then turned inside out to form the finished cover 10 as depicted in FIG. 1.

FIG. 4 illustrates a pictorial view of the embodiment of FIGS. 2 and 3 after the drawstring 14 disposed within hem 22 of the first upper end 20 has been drawn from each end of the hem 22 to close the upper end 20 of the cover 10. The drawstring lock 18, with its plunger 62 depressed, is then slid along the drawstring toward the open ends of the hem 22. Then the plunger is released to secure the drawstring cord 14 around the upper end 20 of the cover 10, thereby closing the upper end 20 of the cover 10.

FIG. 5 illustrates several fishing reel covers in use as installed over the fishing reels of several rod and reel combinations supported on the stern 54 of a boat. The reels of several fishing rods 52, inserted into receptacles 56, 58 in the stern 54 of the boat, are covered with the covers 50 constructed according to the present invention and installed as described with FIG. 4. The drawstring cord 14, pulled through the hem 22 after the cover 10 is installed over the respective reel, is then secured with the drawstring lock 18. Accordingly, rain, dirt and other elements are prevented from affecting the enclosed fishing reels.

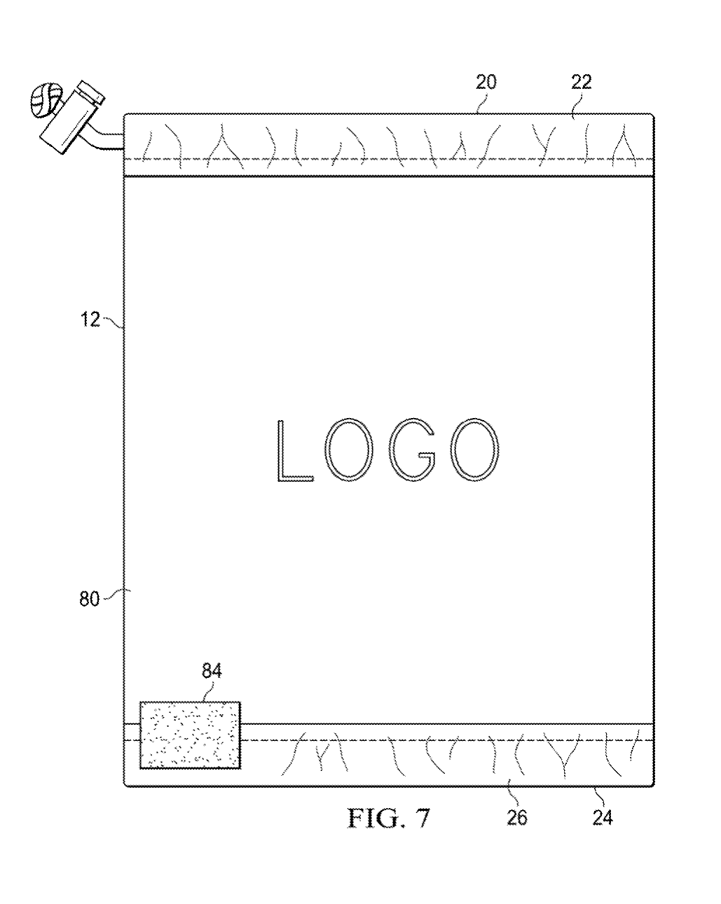

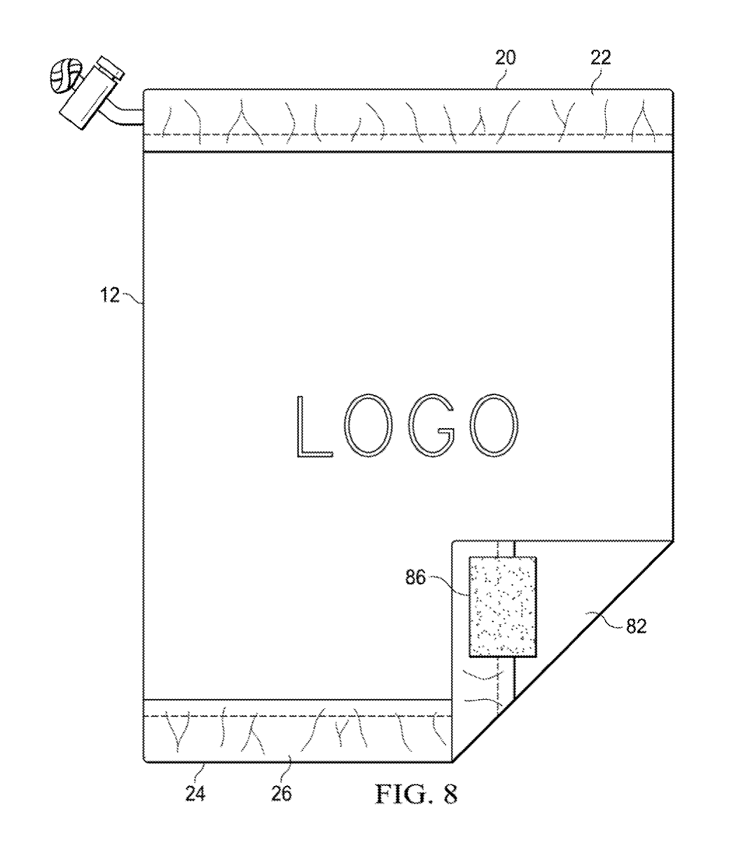

FIGS. 7 and 8 illustrate an alternate embodiment that provides a way to tighten the lower end 24 of the cover 10 around a handle of the fishing rod, using first and second parts of a two piece fastener such as a hook and loop fastener or a snap fastener having male and female parts. In FIG. 7 one member 84 of a hook and loop (or snap) fastener is attached to the left end of the hem 26 of the front side 80 of the cover 10. The hook and loop member may be approximately 1″×1″. In FIG. 8, a second, opposite member 86 of a hook and loop (or snap) fastener is attached to the back side of the cover 10 near the opposite end of the hem 26. If the user needs to enclose the reel more fully at the lower end thereof, the cover corners may be brought together and overlapped so that the hook and loop (or snap) fasteners 84, 86 may be contacted to connect the corners together. The drawings depict the use of hook and loop fasteners to illustrate the concept. Persons skilled in the art will recognize that other two-piece fasteners suitable for the purpose described may also be used.

It should be noted that unlike conventional reel covers the tight closure mechanism at the upper end 20 of the cover 10 not only fully protects the reel but is easily removed when necessary. The cover 10 as described herein can be installed or removed in seconds. Moreover, the open ended bottom design of the cover 10 provides adequate ventilation and provides its protection by not trapping condensation inside the cover to accumulate on the reel. The design of the cover 10 is light in weight and easily packed and stored until use. It can also fit into any shirt, coat or pants pocket between uses. Its compact, flexible design also permits several fishing rods to be positioned close together in a holding rack without the protective covering creating additional girth to the reel.

While the invention has been shown in only one of its forms, it is not thus limited but is susceptible to various changes and modifications without departing from the spirit thereof. The cover described and illustrated herein may include one or more graphic designs such as a logo, tradename, or other distinctive mark or illustration (not shown because of the variability of possible graphics and to preserve the clarity of the drawings) imprinted on its outer surface.

What is claimed is:

1. A cover for a fishing reel on a fishing rod, comprising:
a bag formed from a rectangular piece of waterproof fabric having opposite first and second longer sides and opposite first and second shorter sides; wherein
the first longer side is hemmed with a drawstring cord disposed within the hem, wherein first and second ends of the drawstring cord extend from each end of the hem by a predetermined length to form first and second tie ends;
a hem is formed along the second longer side of the rectangular piece of fabric;
the first and second shorter sides are sewn together along their respective lengths; and
the bag thus formed is turned inside out to dispose an edge of the sewn first and second shorter sides inside the bag.

2. The cover of claim 1, wherein:
the predetermined length that the first and second ends of the drawstring cord extend from each end of the hem along the first longer side is at least two inches.

3. The cover of claim 2, wherein:
the first and second tie ends of the drawstring cord extending from the hem are formed into a knot such that the drawstring cord is retained within the hem.

4. The cover of claim 1, wherein:
a drawstring cord lock is placed over the first and second ends of the drawstring cord extending from the hemmed first longer side and disposed adjacent the ends of the hem.

5. The cover of claim 4, wherein:
the first and second tie ends of the drawstring cord are formed into a knot such that the drawstring cord lock is retained on the drawstring cord between the cover and the knot.

6. The cover of claim 4, wherein the drawstring cord lock comprises:
a spring stopper cord lock having a hollow cylindrical body and a plunger slidably retained therein; wherein
the plunger may be pressed inward of the body against an internal spring to align respective first and second openings in the body and the plunger to permit inserting a cord therethrough to be locked when the plunger is released.

7. The cover of claim 1, wherein:
the waterproof fabric is selected from the group consisting of nylon, synthetic sheet, fabric woven of waterproof fibers, canvas, muslin, and rubberized cloth.

8. The cover of claim 1, wherein the rectangular piece of waterproof fabric is cut to approximately 19 to 20 inches along the first and second longer sides and approximately 13 to 14 inches along the first and second shorter sides.

9. The cover of claim 1, wherein:
sewing the first and second shorter sides together, and turning the bag thus formed inside out, forms a cylindrical cover open at both ends.

10. The cover of claim 1, wherein the hem formed into the first longer side comprises:
an eyelet set into each end of the hem for passage of the draw string.

11. The cover of claim 1, further comprising:
first and second parts of a press-fit fastener attached to opposite sides of the cover and disposed at opposite corners of the lower edge of the cover.

12. The cover of claim 11, wherein the press-fit fastener comprises:
a fastener selected from the group consisting of the first and second parts of a hook and loop fastener, and the first and second parts of a snap fastener.
